(19) United States
(12) Patent Application Publication
(10) Pub. No.: US 2011/0213729 A1
(43) Pub. Date: Sep. 1, 2011

(54) AUTOMATIC SELECTION OF CHEAPEST SUPPLIERS FOR PRODUCT ASSEMBLY

(76) Inventors: Jiri Pechanec, Mokra-Horakov (CZ); Martin Vecera, Brno (CZ)

(21) Appl. No.: 12/713,757

(22) Filed: Feb. 26, 2010

(51) Int. Cl. G06Q 10/00; G06Q 50/00

(52) U.S. Cl. 705/348

(57) ABSTRACT

An apparatus and a method for accepting automatically selecting a combination of suppliers yielding a lowest cost of a product of the suppliers is described. A product analyzer receives from a client a set of parameters of a product. The parameters include a quantity of the product and an identification of the product. The product analyzer gathers cost data of the product from different suppliers of the product based on the set of parameters. An optimal supplier engine of the product analyzer computes a total cost of the product for each combination of the cost data and the set of parameters to determine the combination yielding the lowest total cost.

### TECHNICAL FIELD

Embodiments of the present invention relate to computing systems, and more particularly, to a process for computing a selection of suppliers for a product assembly.

### BACKGROUND

With the advance of electric commerce, users are more comfortable placing online orders for a product with their computers. Every online retailer or product supplier may have their own specific pricing. For example, a book sold from bookstore A may be sold from less at bookstore B. However when additional factors are introduced such as quantities. The computation of the least cost combination order may be complex.

### BRIEF DESCRIPTION OF THE DRAWINGS

The present invention is illustrated by way of example, and not by way of limitation, in the figures of the accompanying drawings and in which:

FIG. 1 is a block diagram illustrating one embodiment of a computer system for determining a selection of suppliers.

FIG. 2 is a block diagram illustrating one embodiment of a product supplier analyzer.

FIG. 3 is a flow diagram illustrating one embodiment of a method for selecting suppliers for a product assembly.

### DETAILED DESCRIPTION

Described herein is an apparatus and a method for accepting automatically selecting a combination of suppliers yielding a lowest cost of a product of the suppliers. A product analyzer receives from a client a set of parameters of a product. The parameters include a quantity of the product and an identification of the product. The product analyzer gathers cost data of the product from different suppliers of the product based on the set of parameters. An optimal supplier engine of the product analyzer computes a total cost of the product for each combination of the cost data and the set of parameters to determine the combination yielding the lowest total cost.

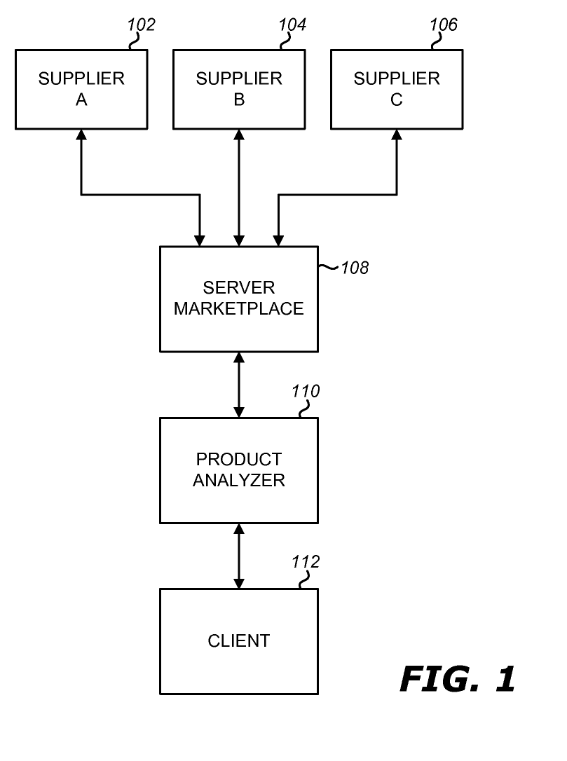

FIG. 1 is a block diagram illustrating one embodiment of a computer system for determining an optimal selection of suppliers. Different suppliers 102, 104, 106 provide a product as specified by a client 112. The product may be an item for sale such as, for example, a book, an electronic product, or a music Compact Disc. In one embodiment, a server marketplace 108 provides a central location for the client to communicate and seek the product.

Client 112 includes a computer system communicating with a product analyzer 110 and the server marketplace 108. Client 112 can include a web browser communicating with the product analyzer 110 and server marketplace 108 over a computer network (LAN, ethernet, Internet). In another embodiment, product analyzer 110 may reside in client 112. In yet another embodiment, product analyzer 110 may reside in server marketplace 108.

Product analyzer 110 receives a set of parameters from client 102. The set of parameters may include a quantity of the sought after product and an identification of the product. For example, client 112 may specify a number of copies of a particular textbook. Then, product analyzer 110 gathers cost data from the different textbook suppliers based on the number of copies of the particular textbook. Because each supplier has a different unit cost based, a different shipping cost and other cost factors associated with the particular textbook, the total cost of the particular textbook may vary from supplier to supplier. Product analyzer 110 is configured to compute a total cost of the product for each combination of the cost data and the set of parameters to determine the combination yielding the lowest total cost. For example, five books may be ordered from a first supplier using a first shipping mode, and another three books may be ordered from a second supplier using a second shipping mode. A shipping mode may include different means and associated costs of shipping. The faster the shipping mode is, the more expensive it typically is. However, other factors affecting the shipping cost may include shipping weight, shipping destination, any shipping discount among others. In the example, where there may be a cap on a shipping discount, it would be beneficial to use another shipping means or shipping company, or order from another supplier.

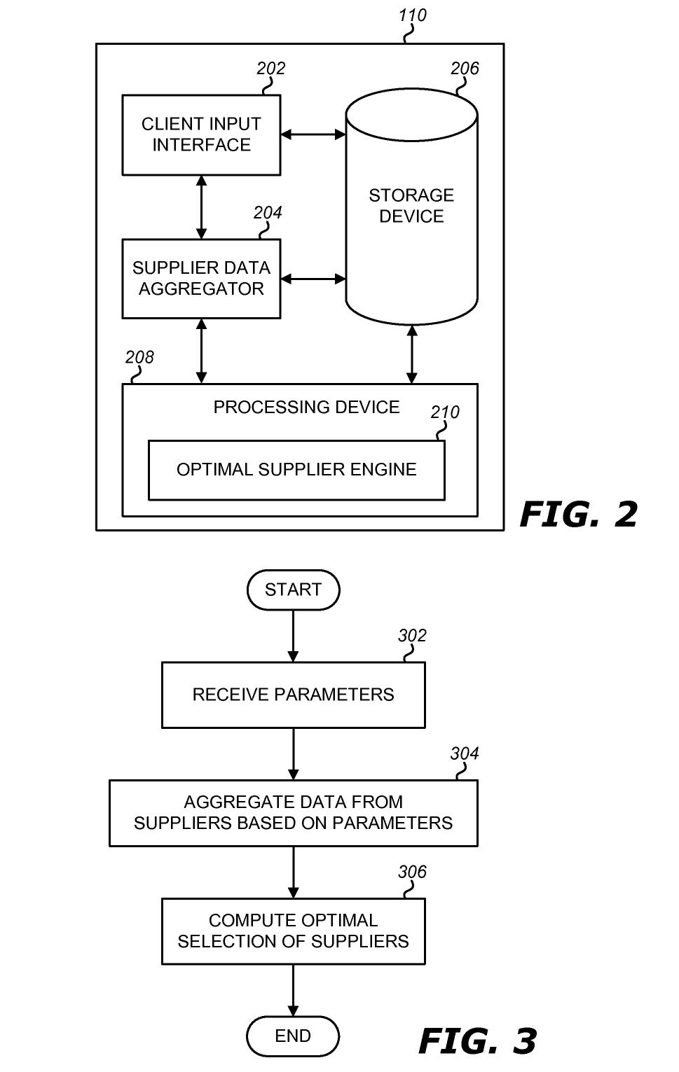

FIG. 2 illustrates a diagrammatic representation of a product analyzer 110 in the exemplary form of a computer system within which a set of instructions, for causing the machine to perform any one or more of the methodologies discussed herein, may be executed. In alternative embodiments, the machine 110 may be connected (e.g., networked) to other machines in a LAN, an intranet, an extranet, or the Internet. The machine 110 may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system includes a client input interface 202, a supplier data aggregator 204, a processing device 208, a main memory (e.g., read-only memory (ROM), flash memory, dynamic random access memory (DRAM) such as synchronous DRAM (SDRAM), a static memory (e.g., flash memory, static random access memory (SRAM), etc.), and a data storage device 206, which communicate with each other via a bus.

Client input interface 202 communicates with client 112 and receives a set of parameters from client 112. In one embodiment, the set of parameters includes a quantity of the product and an identification of the product. In another embodiment, the set of parameters also includes a destination parameter, a membership parameter, a shipping means parameter, a discount code parameter, and a payment means parameter.

The destination parameter may include an address or location of where the product is to be delivered. The membership parameter may include whether a user placing the order client 112 belongs to a membership associated with any suppliers. Such membership would allow for an additional discount or preferred pricing of the product. The shipping means parameter includes specifying a means for delivering the product. Such means may include selecting a particular shipping company, selecting a time frame for the delivery (how fast). The discount code parameter may include a predefined promotional/discount code to encourage placing the order with a particular supplier. The payment means parameter may include the type of payment submitted by the user of client 112. For example, a discount may be provided for using a particular means of payment (check or debit card instead of credit card). In another example, a discount may be provided for using a particular type of credit card over other types of credit card since different credit cards charge different transaction fees.

Supplier data aggregator 204 pulls or gather data cost data of the product from the different suppliers of the selected product based on the set of parameters. The cost data can include for example, a cost per unit from each supplier, a quantity discount factor from each supplier, a discount code parameter for each supplier, a membership parameter for each supplier, a shipping cost parameter for each supplier, a shipping means parameter for each supplier, a payment means parameter, and a sales tax parameter for each supplier.

The cost per unit for the specified product may vary with different suppliers. Each supplier may provide a different discount based on the quantity ordered of the product. Each supplier may have their own promotional (permanent or temporary) discount code. Each supplier may have their own loyalty reward membership program (one gets a discount by frequently ordering from the same supplier). Each supplier may have different shipping costs and use different shipping means. Also, each supplier may have their own payment means parameter and a sales tax parameter. Those of ordinary skill in the art will recognize that other parameters may be included in the cost data aggregated from each supplier.

In one embodiment, data storage device may include one or more databases to store the pulled data from the suppliers for future faster computation and the selected products. The data may be updated periodically to reflect the most up to date cost.

Processing device 208 includes the following module: an optimal supplier engine 210 configured to determine the optimal combination of suppliers for a specific product. Optimal supplier engine 210 computes a total cost of the product for each combination of the cost data and the set of parameters to determine the combination (e.g. x units from supplier A using shipper B with discount code C, y units from supplier C using shipper D with membership code E) with yielding the lowest total cost.

In one embodiment, the computation uses a maximum flow problem algorithm to determine the combination yielding the lowest total cost. The data and the set of parameters are presented with an oriented graph. A maximum flow is computed to determine an optimal path for the oriented graph. Other algorithms may be used to determine the most efficient combination.

Optimal supplier engine may also be configured to rank the total cost based on the different combinations of suppliers. The information is sent back to client 112 for selection. User of client 112 may not necessarily select the lowest cost combination. Other factors (e.g. political factors) may determine the final combination selection.

Processing device 208 represents one or more general-purpose processing devices such as a microprocessor, central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device may also be one or more special-purpose processing devices such as an application specific integrated circuit (ASIC), a field programmable gate array (FPGA), a digital signal processor (DSP), network processor, or the like. The processing device is configured to execute modules 210 for performing the operations and steps discussed herein with. In one embodiment, modules 210 may be include hardware or software or a combination of both.

The computer system may further include a network interface device. The computer system also may include a video display unit (e.g., a liquid crystal display (LCD) or a cathode ray tube (CRT)), an alphanumeric input device (e.g., a keyboard), a cursor control device (e.g., a mouse), and a signal generation device (e.g., a speaker).

Data storage device 206 may include a non-transitory computer-accessible storage medium on which is stored one or more sets of instructions embodying any one or more of the methodologies or functions described herein. The software may also reside, completely or at least partially, within the main memory and/or within the processing device during execution thereof by the computer system, the main memory and the processing device also constituting computer-accessible storage media. The software may further be transmitted or received over a network via the network interface device.

The computer-accessible storage medium may also be used to store unpacked new and released builds. While the computer-accessible storage medium is shown in an exemplary embodiment to be a single medium, the term “computer-accessible storage medium” should be taken to include a single medium or multiple media (e.g., a centralized or distributed database, and/or associated caches and servers) that store the one or more sets of instructions. The term “computer-accessible storage medium” shall also be taken to include any medium that is capable of storing, encoding or carrying a set of instructions for execution by the machine and that cause the machine to perform any one or more of the methodologies of the present invention. The term “computer-accessible storage medium” shall accordingly be taken to include, but not be limited to, solid-state memories, optical and magnetic media.

FIG. 3 is a flow diagram illustrating one embodiment of a method for selecting suppliers for a product assembly. At 302, a product analyzer 110 receives a set of parameters of a product from a client. The parameters includes for example, a quantity of the product and an identification of the product. At 304, cost data of the product is gathered from different suppliers of the product based on the set of parameters with a supplier data aggregator module of the product analyzer. At 306, a total cost of the product is computed for each combination of the cost data and the set of parameters to determine the combination yielding the lowest total cost. In one embodiment, the computation algorithm includes presenting the data and the set of parameters with an oriented graph, and computing a maximum flow to determine an optimal path for the oriented graph.

In one embodiment, the cost data for each supplier can be stored in storage device of the product analyzer. The total cost can be ranked based on the different combinations of suppliers (or other factors).

For illustration purposes, the set of parameters comprises a destination parameter, a membership parameter, a shipping means parameter, a discount code parameter, and a payment means parameter. The cost data comprises a cost per unit from each supplier, a quantity discount factor from each supplier, a discount code parameter for each supplier, a membership parameter for each supplier, a shipping cost parameter for each supplier, a shipping means parameter for each supplier, a payment means parameter, and a sales tax parameter for each supplier.

In another embodiment, the product analyzer receives a set of parameters of a first product and a set of parameters of a second product, gathers cost data of the first product from a plurality of suppliers of the first product based on the set of parameters of the first product, gathers cost data of the second product from the different suppliers of the second product based on the set of parameters of the second product, computes a total cost of the first and second product based on a combination of the cost data of the first and second product and the set of parameters of the first and second product, and determines the combination of suppliers of the first and second product yielding the lowest total cost.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
receiving a set of parameters of a product from a client at a product analyzer, the parameters comprising a quantity of the product and an identification of the product;
gathering cost data of the product from a plurality of suppliers of the product based on the set of parameters with a supplier data aggregator module of the product analyzer;
computing a total cost of the product for each combination of the cost data and the set of parameters; and
determining the combination yielding the lowest total cost.

2. The computer-implemented method of claim 1 wherein computing further comprises:
presenting the data and the set of parameters with an oriented graph; and
computing a maximum flow to determine an optimal path for the oriented graph.

3. The computer-implemented method of claim 1 further comprising:
storing the cost data for each supplier in storage device of the product analyzer; and
ranking the total cost based on the different combinations of suppliers.

4. The computer-implemented method of claim 1 wherein the set of parameters further comprises a destination parameter, a membership parameter, a shipping means parameter, a discount code parameter, and a payment means parameter.

5. The computer-implemented method of claim 1 wherein the cost data further comprises a cost per unit from each supplier, a quantity discount factor from each supplier, a discount code parameter for each supplier, a membership parameter for each supplier, a shipping cost parameter for each supplier, a shipping means parameter for each supplier, a payment means parameter, and a sales tax parameter for each supplier.

6. The computer-implemented method of claim 1 further comprising:
receiving a set of parameters of a first product and a set of parameters of a second product;
gathering cost data of the first product from a plurality of suppliers of the first product based on the set of parameters of the first product;
gathering cost data of the second product from a plurality of suppliers of the second product based on the set of parameters of the second product;
computing a total cost of the first and second product based on a combination of the cost data of the first and second product and the set of parameters of the first and second product; and
determining the combination of suppliers of the first and second product yielding the lowest total cost.

7. The computer-implemented method of claim 1 wherein the combination yielding the lowest total cost includes a quantity of the product for each supplier, a discount code parameter for each supplier, a membership parameter for each supplier, a shipping cost parameter for each supplier, a shipping means parameter for each supplier, a payment means parameter for each supplier.

8. A non-transitory computer-readable storage medium, having instructions stored therein, which when executed, cause a computer system to perform a method comprising:
receiving a set of parameters of a product from a client at a product analyzer, the parameters comprising a quantity of the product and an identification of the product;
gathering cost data of the product from a plurality of suppliers of the product based on the set of parameters with a supplier data aggregator module of the product analyzer;
computing a total cost of the product for each combination of the cost data and the set of parameters; and
determining the combination yielding the lowest total cost.

9. The non-transitory computer-readable storage medium of claim 8 wherein computing further comprises:
presenting the data and the set of parameters with an oriented graph; and
computing a maximum flow to determine an optimal path for the oriented graph.

10. The non-transitory computer-readable storage medium of claim 8 wherein the method further comprises:
storing the cost data for each supplier in storage device of the product analyzer; and
ranking the total cost based on the different combinations of suppliers.

11. The non-transitory computer-readable storage medium of claim 8 wherein the set of parameters further comprises a destination parameter, a membership parameter, a shipping means parameter, a discount code parameter, and a payment means parameter.

12. The non-transitory computer-readable storage medium of claim 8 wherein the cost data further comprises a cost per unit from each supplier, a quantity discount factor from each supplier, a discount code parameter for each supplier, a membership parameter for each supplier, a shipping cost parameter for each supplier, a shipping means parameter for each supplier, a payment means parameter, and a sales tax parameter for each supplier.

13. The non-transitory computer-readable storage medium of claim 8 wherein the method further comprises:
receiving a set of parameters of a first product and a set of parameters of a second product;
gathering cost data of the first product from a plurality of suppliers of the first product based on the set of parameters of the first product;
gathering cost data of the second product from a plurality of suppliers of the second product based on the set of parameters of the second product;
computing a total cost of the first and second product based on a combination of the cost data of the first and second product and the set of parameters of the first and second product; and
determining the combination of suppliers of the first and second product yielding the lowest total cost.

14. The non-transitory computer-readable storage medium of claim 8 wherein the combination yielding the lowest total cost includes a quantity of the product for each supplier, a discount code parameter for each supplier, a membership parameter for each supplier, a shipping cost parameter for each supplier, a shipping means parameter for each supplier, a payment means parameter for each supplier.

15. A computer system comprising:
a client input interface configured to receive a set of parameters of a product from a client, the parameters comprising a quantity of the product and an identification of the product;
a supplier data aggregator coupled to the client input interface, the supplier data aggregator configured to gather cost data of the product from a plurality of suppliers of the product based on the set of parameters; and
a processing device coupled to the client input interface and the supplier data aggregator, the processing device configured to compute a total cost of the product for each combination of the cost data and the set of parameters, and to determine the combination yielding the lowest total cost.

16. The computer system of claim 15 wherein the processing device is further configured to present the data and the set of parameters with an oriented graph, and compute a maximum flow to determine an optimal path for the oriented graph.

17. The computer system of claim 15 further comprising a storage device coupled to the supplier data aggregator, the storage device configured to store the gathered cost data of the product from the plurality of suppliers of the product, the processing device configured to rank the total cost based on the different combinations of suppliers, wherein the combination yielding the lowest total cost includes a quantity of the product for each supplier, a discount code parameter for each supplier, a membership parameter for each supplier, a shipping cost parameter for each supplier, a shipping means parameter for each supplier, a payment means parameter for each supplier.

18. The computer system of claim 15 wherein the set of parameters further comprises a destination parameter, a membership parameter, a shipping means parameter, a discount code parameter, and a payment means parameter.

19. The computer system of claim 15 wherein the cost data further comprises a cost per unit from each supplier, a quantity discount factor from each supplier, a discount code parameter for each supplier, a membership parameter for each supplier, a shipping cost parameter for each supplier, a shipping means parameter for each supplier, a payment means parameter, and a sales tax parameter for each supplier.

20. The computer system of claim 15 wherein the processing device is further configured to:
receive a set of parameters of a first product and a set of parameters of a second product;
gather cost data of the first product from a plurality of suppliers of the first product based on the set of parameters of the first product;
gather cost data of the second product from a plurality of suppliers of the second product based on the set of parameters of the second product;
compute a total cost of the first and second product based on a combination of the cost data of the first and second product and the set of parameters of the first and second product; and
determine the combination of suppliers of the first and second product yielding the lowest total cost.
